(19) United States
(12) Patent Application Publication
(10) Pub. No.: US 2026/0237374 A1
(43) Pub. Date: Aug. 13, 2026

(54) AUDIO PROCESSING CIRCUIT USING LEAKAGE DETECTION TO CONTROL ONE OR MORE ADAPTIVE NON-ACTIVE NOISE CONTROL FILTERS AND ASSOCIATED METHOD

(71) Applicant: Airoha Technology Corp., Hsinchu City (TW)

(72) Inventors: Li-Wen Chi, Hsinchu County (TW); Chih-Chi Weng, Hsinchu County (TW)

(73) Assignee: Airoha Technology Corp., Hsinchu City (TW)

(21) Appl. No.: 19/284,728

(22) Filed: Jul. 30, 2025

Related U.S. Application Data
(60) Provisional application No. 63/756,811, filed on Feb. 11, 2025.

(51) Int. Cl. G10K 11/178

(52) U.S. Cl. CPC G10K 11/17854; G10K 11/17815; G10K 11/17817; G10K 11/17881

(57) ABSTRACT

An audio processing circuit includes at least one audio filter, at least one adaptive non-active noise control (non-ANC) filter, and a leakage detection circuit. The at least one audio filter controls an output signal for an audio function. The at least one adaptive non-ANC filter generates at least one non-anti-noise signal according to an audio playback signal. The leakage detection circuit performs leakage detection according to a first input signal and a second input signal, and adjusts the at least one adaptive non-ANC filter according to a leakage detection result, wherein the first input signal is indicative of noise signal signature, and the second input signal is derived from an error signal output by an error microphone that picks up remnant noise resulting from the audio function.

### CROSS REFERENCE TO RELATED APPLICATIONS

This application claims the benefit of U.S. Provisional Application No. 63/756,811, filed on Feb. 11, 2025. The content of the application is incorporated herein by reference.

### BACKGROUND OF THE INVENTION

### 1. Field of the Invention

The present invention relates to an audio function (e.g., a noise reduction/cancellation mode or a pass-through mode), and more particularly, to an audio processing circuit using leakage detection to control one or more adaptive non-active noise control (non-ANC) filters and an associated method.

### 2. Description of the Prior Art

Active noise control (ANC) can cancel the unwanted noise based on the principle of superposition. Specifically, an anti-noise signal of equal amplitude and opposite phase is generated and combined with the unwanted noise signal, thus resulting in cancellation of both noise signals at a local quite zone (e.g. user's ear drum). Compared to a static ANC technique using filter coefficients that are tuned and fixed in a factory, an adaptive ANC technique is capable of finding better filter coefficients for users with different wearing styles. However, the stability of the adaptive ANC technique is worse than that of the static ANC technique, and the control difficulty and complexity of the adaptive ANC technique is higher than that of the static ANC technique. For example, the adaptive ANC technique may adopt a least mean square (LMS) based algorithm to adjust ANC filter coefficients.

The adaptive ANC filter(s) may co-work with non-ANC filter(s) used to generate non-anti-noise signal(s). When the non-ANC filter is implemented by a static filter, it may fail to generate an appropriate non-anti-noise signal for a leakage condition. When the non-ANC filter is implemented by an adaptive filter, the LMS based algorithm is typically adopted to adjust filter coefficients of the non-ANC filter, which incurs computational complexity due to lots of convolution processes. Thus, there is a need for an innovative control scheme of adaptive non-ANC filters.

### SUMMARY OF THE INVENTION

One of the objectives of the claimed invention is to provide an audio processing circuit using leakage detection to control one or more adaptive non-ANC filters and an associated method.

According to a first aspect of the present invention, an exemplary audio processing circuit is disclosed. The exemplary audio processing circuit includes at least one audio filter, at least one adaptive non-ANC filter, and a leakage detection circuit. The at least one audio filter is arranged to control an output signal for an audio function. The at least one adaptive non-ANC filter is arranged to generate at least one non-anti-noise signal according to an audio playback signal. The leakage detection circuit is arranged to perform leakage detection according to a first input signal and a second input signal, and adjust the at least one adaptive non-ANC filter according to a leakage detection result, wherein the first input signal is indicative of noise signal signature, and the second input signal is derived from an error signal output by an error microphone that picks up remnant noise resulting from the audio function.

According to a second aspect of the present invention, an exemplary audio processing method is disclosed. The exemplary audio processing method includes: controlling, by at least one audio filter, an output signal for an audio function; generating, by at least one adaptive non-ANC filter, at least one non-anti-noise signal according to an audio playback signal; performing leakage detection according to a first input signal and a second input signal, wherein the first input signal is indicative of noise signal signature, and the second input signal is derived from an error signal output by an error microphone that picks up remnant noise resulting from the audio function; and adjusting the at least one adaptive non-ANC filter according to a leakage detection result.

According to a third aspect of the present invention, an exemplary audio processing circuit is disclosed. The exemplary audio processing circuit includes at least one adaptive non-active noise control (non-ANC) filter and a leakage detection circuit. The at least one adaptive non-ANC filter is arranged to generate at least one non-anti-noise signal according to an audio playback signal. The leakage detection circuit is arranged to perform leakage detection according to a first input signal indicative of noise signal signature and a second input signal derived from an error signal, and adjust the at least one adaptive non-ANC filter according to a leakage detection result, wherein the at least one adaptive non-ANC filter is adjusted without being applied a least mean square (LMS) based algorithm.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an audio processing system according to an embodiment of the present invention.

FIG. 2 is a diagram illustrating a first adaptive ANC system with leakage detection according to an embodiment of the present invention.

FIG. 3 is a diagram illustrating a second adaptive ANC system with leakage detection according to an embodiment of the present invention.

FIG. 4 is a diagram illustrating a third adaptive ANC system with leakage detection according to an embodiment of the present invention.

FIG. 5 is a diagram illustrating a fourth adaptive ANC system with leakage detection according to an embodiment of the present invention.

FIG. 6 is a diagram illustrating a fifth adaptive ANC system with leakage detection according to an embodiment of the present invention.

FIG. 7 is a diagram illustrating a sixth adaptive ANC system with leakage detection according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

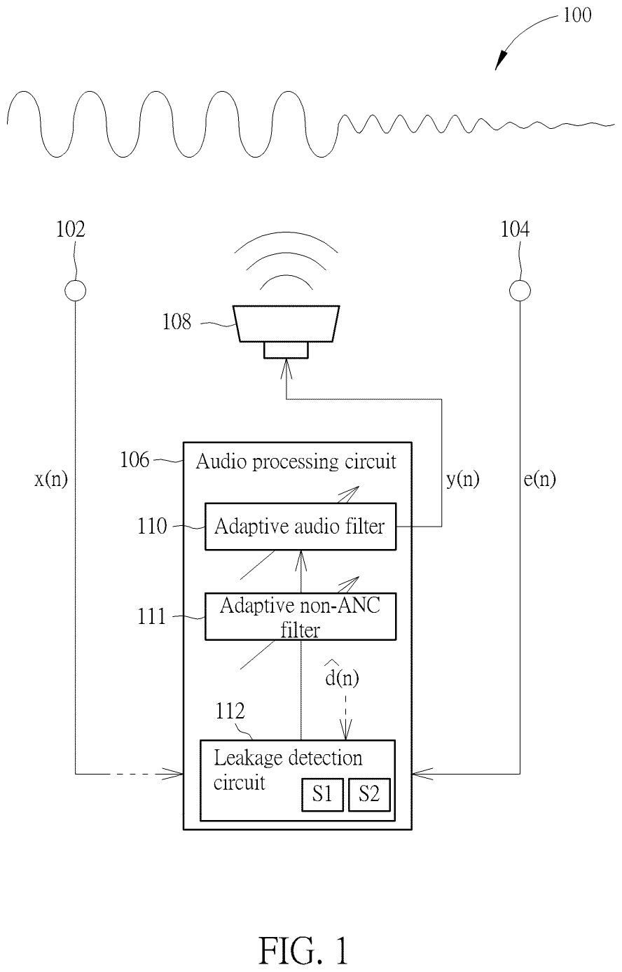

FIG. 1 is a diagram illustrating an audio processing system according to an embodiment of the present invention. The audio processing system 100 may be installed on an earphone device such as an earbud. In this embodiment, the audio processing system 100 includes a reference microphone 102, an error microphone 104, an audio processing circuit 106, and a speaker 108. In this embodiment, the audio processing circuit 106 includes at least one adaptive audio filter 110, at least one adaptive non-ANC filter 111, and a leakage detection circuit 112. Each adaptive audio filter 110 may be a main filter of the audio processing system 100 for achieving a main audio function of the audio processing system 100. For example, each adaptive audio filter 110 may be an adaptive ANC filter. For another example, each adaptive audio filter 110 may be a pass-through (PT) filter.

For better comprehension of technical features of the present invention, the following assumes that the audio processing system 100 is an adaptive ANC system, the audio processing circuit 106 is an ANC circuit, and each adaptive audio filter 110 is an adaptive ANC filter. Hence, in the following, the terms “audio processing circuit” and “ANC circuit” may be interchangeable, and the terms “adaptive audio filter” and “adaptive ANC filter” may be interchangeable.

The ANC circuit 106 is arranged to generate an output signal (e.g., anti-noise signal) y(n) for an audio function (e.g., noise reduction/cancellation). Specifically, the anti-noise signal y(n) may be a digital signal that is transmitted to the speaker 108 for playback of analog anti-noise, where the analog anti-noise is intended to reduce/cancel the unwanted ambient noise through superposition. The ANC circuit 106 includes at least one adaptive ANC filter 110 each arranged to estimate the unknown transfer function of a primary path from the reference microphone 102 to a position where the noise reduction/cancellation is to be realized. In this embodiment, each adaptive ANC filter 110 can be adaptively adjusted by a leakage detection circuit 112. It should be noted that the number of adaptive ANC filters 110 used by the ANC circuit 106 may depend on the adaptive ANC structure employed by the ANC circuit 106. For example, the ANC circuit 106 may employ an adaptive feedforward (FF) ANC structure, an adaptive feedback (FB) ANC structure, or an adaptive hybrid ANC structure which is a combination of an adaptive FF ANC structure and an adaptive FB ANC structure. In other words, the adaptive ANC filter(s) 110 may be a part of an adaptive FF ANC structure, an adaptive FB ANC structure, or an adaptive hybrid ANC structure.

In this embodiment, the ANC circuit 106 further includes at least one adaptive non-ANC filter 111 each arranged to generate a non-anti-noise signal. For example, the adaptive non-ANC filter(s) 111 may include an audio equalization (EQ) filter, an audio signal compensation filter (e.g., a feedback compensation (FBC) filter), or a combination thereof. Hence, when there is an audio equalization filter co-working with the adaptive ANC filter(s) 110, ANC with audio equalization can be achieved; when there is an audio signal compensation filter co-working with the adaptive ANC filter(s) 110, ANC with audio signal compensation can be achieved; and when there are an audio equalization filter and an audio signal compensation filter both co-working with the adaptive ANC filter(s) 110, ANC with audio equalization and audio signal compensation can be achieved. It should be noted that, based on actual application requirements, the non-anti-noise signal output from each adaptive non-ANC filter 111 may also be provided to the speaker 108 for playback of analog non-anti-noise signal.

The reference microphone 102 is arranged to pick up ambient noise from an external noise source, and generate a reference signal x(n). The error microphone 104 is arranged to pick up remnant noise resulting from the audio function (e.g., noise reduction/cancellation), and generate an error signal e(n). One or both of the reference signal x(n) and the error signal e(n) may be used by the leakage detection circuit 112 for adaptively adjusting the adaptive ANC filter(s) 110 and the adaptive non-ANC filter(s) 111. In this embodiment, the leakage detection circuit 112 is arranged to perform leakage detection according to a first input signal S1 and a second input signal S2, and adjust the adaptive non-ANC filter(s) 110 and the adaptive non-ANC filter(s) 111 according to a leakage detection result, where the first input signal S1 is indicative of noise signal signature (e.g., noise signal magnitude), and the second input signal S2 is derived from the error signal e(n) output by the error microphone 104 that picks up remnant noise resulting from the audio function (e.g., noise reduction/cancelation). It should be noted that the first input signal S1 is not a downlink (DL) reference signal (e.g., a playback reference signal). In addition, the leakage detection function can operate at the time the ANC function is enabled. In some embodiments of the present invention, the first input signal S1 may be derived from the reference signal x(n) output by the reference microphone 102 that picks up ambient noise. In some embodiments of the present invention, the reference microphone 102 is unavailable, and the first input signal S1 may be derived from an estimated signal \hat{d}(n) of a noise signal at a position where the audio function (e.g., noise reduction/cancellation) occurs.

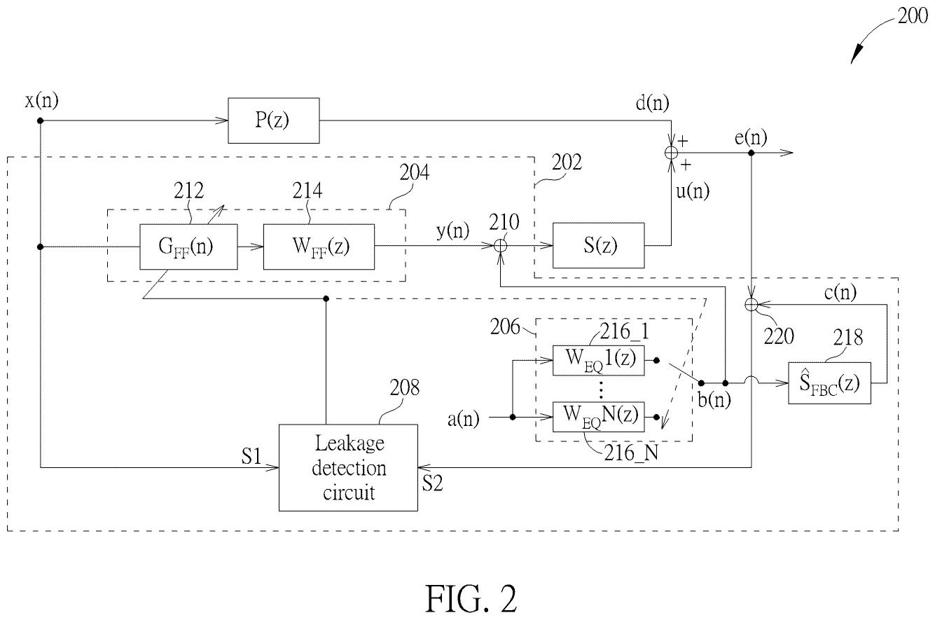

FIG. 2 is a diagram illustrating a first adaptive ANC system with leakage detection according to an embodiment of the present invention. The adaptive ANC system 200 includes an ANC circuit 202. The ANC circuit 202 includes an adaptive ANC filter 204, an adaptive non-ANC filter 206, a static non-ANC filter 218, a combining circuit 220, and a leakage detection circuit 208. The audio processing circuit (e.g., ANC circuit) 106 shown in FIG. 1 may be realized by the ANC circuit 202. The transfer function of an acoustic channel, also called the primary path, between the reference signal x(n) (which is the ambient noise picked up by the reference microphone 102) and a noise signal d(n) at a position where noise reduction/cancellation occurs is represented by P(z). The transfer function of an electro-acoustic channel, also called the secondary path, between the anti-noise signal y(n) (which is an ANC filter output) and the error signal e(n) (which is the remnant noise picked by the error microphone 104) is represented by S(z). Hence, regarding the acoustic superposition in the space from the ANC circuit 202 to the error microphone 104, there is a signal u(n) resulting from passing the anti-noise signal y(n) through the secondary path transfer function S(z). The error signal e(n) may be a superposition result of the signal u(n) and the noise signal d(n).

In this embodiment, the ANC circuit 202 employs an adaptive FF ANC structure having the adaptive ANC filter 204 included therein, where an input of the adaptive ANC filter 204 is derived from the reference signal x(n). As shown in FIG. 2, the adaptive ANC filter 204 is implemented by an adaptive gain amplifier 212 and a static filter 214 (also an ANC filter) connected in series, where the static filter 214 has a fixed transfer function W_{FF}(z) defined by fixed filter coefficients, and the adaptive gain amplifier 212 has a controllable gain G_{FF}(n). The leakage detection circuit 208 is arranged to perform leakage detection according to a first input signal S1 and a second input signal S2, and adjust the controllable gain G_{FF}(n) of the adaptive gain amplifier 212 according to a leakage detection result. In this embodiment, the first input signal S1 is set by the reference signal x(n) (i.e., S1=x(n)), and the second input signal S2 is set by the error signal e(n) (i.e., S2=e(n)). Hence, the leakage detection circuit 208 may obtain the leakage detection result through calculating a ratio of the second input signal S2 to the first input signal S1 (i.e.,

$$\frac{E ( z )}{X ( z )}$$

as a leakage detection factor which is proportional to the leakage condition.

Signals of the adaptive ANC system 200 may be expressed using the following formulas.

$$e ( n ) = d ( n ) + x ( n ) * {G}_{F F} * {W}_{F F} * S \qquad ( 1 )$$

$$E ( z ) = X ( z ) P ( z ) + X ( z ) S ( z ) {G}_{F F} ( z ) {W}_{F F} ( z ) \qquad ( 2 )$$

$$E ( z ) = X ( z ) * ( P ( z ) + S ( z ) {G}_{F F} ( z ) {W}_{F F} ( z ) ) \qquad ( 3 )$$

$$\frac{E ( z )}{X ( z )} = P ( z ) + S ( z ) {G}_{F F} ( z ) {W}_{F F} ( z ) \qquad ( 4 )$$

If S(z)G_{FF}(z)W_{FF}(z) approaches to P(z), E(z) approaches to zero. The

$$\frac{E ( z )}{X ( z )}$$

ratio also could be taken as a leakage detection factor. The ratio is directly proportional to the leakage condition and the filter gain. In other words, when the leakage detection factor becomes larger, the filter coefficients should be larger, resulting in a larger filter gain; and when the leakage detection factor becomes smaller, the filter coefficients should be smaller, resulting in a smaller filter gain.

The leakage detection algorithm has lower computation complexity than any LMS-based algorithm. Hence, the proposed ANC circuit 202 with leakage detection has lower computation complexity since it does not use any LMS-based algorithm. Alternatively, the

$$\frac{E ( z )}{X ( z )}$$

ratio used by the proposed leakage detection algorithm may be calculated using an LMS-based algorithm. Compared to a conventional filter controller design that adjusts filter coefficients of an adaptive filter by using an LMS-based algorithm that needs to operate at, for example, 192 KHz and 1024 taps, the proposed leakage detection algorithm only needs an LMS-based algorithm that operates at, for example, 8 KHz and 128 taps to perform filter selection or filter gain adjustment. To put it simply, the

$$\frac{E ( z )}{X ( z )}$$

ratio used by the proposed leakage detection algorithm may be obtained with/without the use of an LMS-based algorithm. No matter whether an LMS-based algorithm is used, the leakage detection algorithm has lower computation complexity compared to the conventional filter controller design.

It should be noted that the adaptive gain amplifier 212 is a linear time-invariant (LTI) system, and the adaptive gain amplifier 212 and the static filter 214 may be swapped. In other words, the adaptive gain amplifier 212 may be put before or after the static filter 214, depending upon actual design considerations.

In this embodiment, the adaptive non-ANC filter 206 is an audio equalization filter. The speaker's response is attenuated by the leakage condition. For example, the secondary path transfer function S(z) may vary due to different leakage conditions resulting from user's different wearing styles of the earphone device. Hence, the audio equalization filter can be used to compensate the attenuation caused by the leakage condition. Specifically, the adaptive non-ANC filter (i.e., audio equalization filter) 206 is arranged to receive an audio playback signal a(n), and generate an audio equalization signal b(n) according to the audio playback signal a(n); and the combining circuit 210 is arranged to combine the anti-noise signal y(n) and the audio equalization signal b(n).

In addition, the static non-ANC filter 218 acts as a feedback compensation filter, and has a fixed transfer function Ŝ_{FBC}(z) defined by fixed filter coefficients. The fixed transfer function Ŝ_{FBC}(z) may be an estimation of the secondary path transfer function S(z). The static non-ANC filter 218 is arranged to receive the audio equalization signal b(n), and generate an audio signal compensation signal c(n) according to the audio equalization signal b(n). The combining circuit 220 is arranged to combine the error signal e(n) and the audio signal compensation signal c(n) for reducing or removing the audio playback signal component present in the error signal e(n). In this way, interference of the leakage detection that results from the audio playback signal component in the error signal e(n) can be mitigated or removed. However, the static non-ANC filter 218 and the combining circuit 220 may be optional, depending upon actual design considerations. For example, in an alternative design, the static non-ANC filter 218 and the combining circuit 220 may be omitted, and the function of reducing or removing the audio playback signal component present in the error signal e(n) can be integrated into the leakage detection circuit 208. The same objective of mitigating or removing the interference of the leakage detection that results from the audio playback signal component in the error signal e(n) is achieved.

The adaptive non-ANC filter (i.e., audio equalization filter) 206 may be implemented by a selective filter having a plurality of static filters 216_1-216_N (N≥2), where the static filter 216_1 has a fixed transfer function (i.e., a fixed EQ frequency response curve) W_{EQ}1(z) defined by fixed filter coefficients, and the static filter 216_N has a fixed transfer function (i.e., a fixed EQ frequency response curve) W_{EQ}N(z) defined by fixed filter coefficients. The leakage detection circuit 208 is further arranged to select one of the static filters 216_1-216_N as an active audio equalization filter of the adaptive non-ANC filter 206 according to the leakage detection result. The leakage detection algorithm has lower computation complexity than any LMS-based algorithm. Hence, the proposed leakage detection can help to select a proper equalization filter to compensate the attenuation of the speaker's response with lower computation complexity. In this way, the audio playback quality can be enhanced after compensation of the attenuation of the speaker's response. Specifically, pre-defined filters 216_1-216_N can fit the secondary path transfer function to enhance audio quality with lower computation complexity.

In a conventional filter controller design, the error signal is involved in adjusting filter coefficients of an adaptive audio equalization filter. If an ANC filter is enabled during a period in which the conventional filter controller is in operation, the error signal contains the audio playback signal component as well as the anti-noise signal component. The conventional filter controller may refer to the anti-noise signal component (which is an unwanted signal component) to perform filter coefficient adjustment upon the adaptive audio equalization filter. As a result, the performance of the adaptive audio equalization filter is degraded due to inaccurate filter coefficient settings, causing poorer audio playback quality. To improve the accuracy of adjusting filter coefficients of the adaptive audio equalization filter under a condition that the ANC filter is enabled, the conventional filter controller may need to use an LMS-based algorithm with high complexity.

Compared to the conventional filter controller using an LMS-based algorithm with high complexity, the proposed leakage detection algorithm simply selects a proper audio equalization filter from the static filters 216_1-216_N, where the static filters 216_1-216_N may be pre-verified to meet requirements of different leakage conditions in which presence of the anti-noise signal component in the error signal is taken into consideration. In other words, the transfer function (i.e., EQ frequency response curves) W_{EQ}1(z) of the static filter 216_1 is properly tuned in the factory for the 1^{st} leakage condition in which the anti-noise signal component is present in the error signal, and the transfer function (i.e., EQ frequency response curves) W_{EQ}N(z) of the static filter 216_N is properly tuned in the factory for the N^{th} leakage condition in which the anti-noise signal component is present in the error signal. Hence, in an actual usage case, the proposed leakage detection algorithm simply selects a proper audio equalization filter from the pre-verified static filters 216_1-216_N in response to a current leakage condition, without the need of an LMS-based algorithm with high complexity.

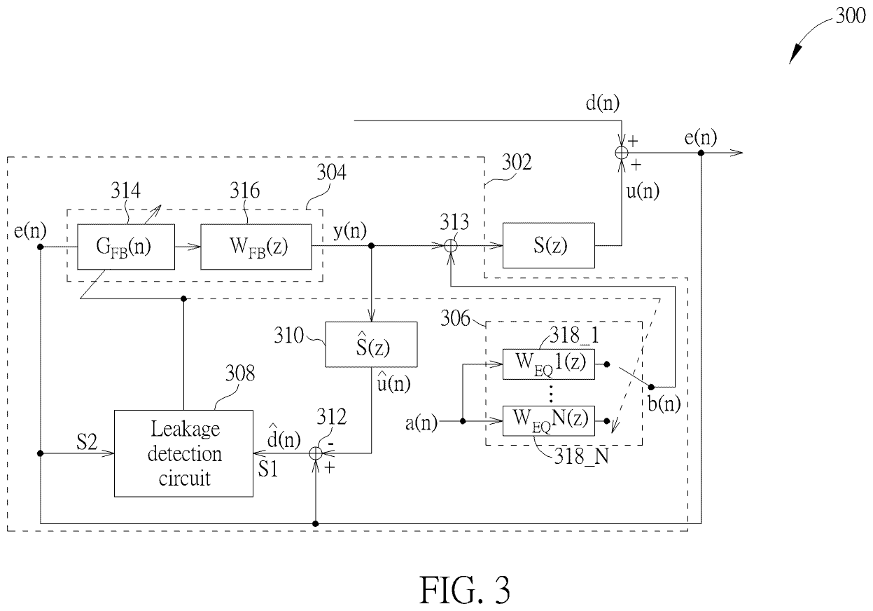

In some embodiments of the present invention, it is possible that the adaptive ANC system may have only a single microphone (e.g., the error microphone 104 shown in FIG. 1). Since the reference microphone 102 shown in FIG. 1 is absent, the reference signal x(n) is not available to the leakage detection. One of the input signals needed by the leakage detection may be set by an estimated signal \hat{d}(n) of the noise signal d(n) at a position where the noise reduction/cancellation occurs, as described in detail in FIG. 3.

FIG. 3 is a diagram illustrating a second adaptive ANC system with leakage detection according to an embodiment of the present invention. The adaptive ANC system 300 includes an ANC circuit 302. The ANC circuit 302 includes an adaptive ANC filter 304, an adaptive non-ANC filter 306, a leakage detection circuit 308, a filter 310, and combining circuits 312 and 313. The audio processing circuit (e.g., ANC circuit) 106 shown in FIG. 1 may be realized by the ANC circuit 302. In this embodiment, the ANC circuit 302 employs an adaptive FB ANC structure having the adaptive ANC filter 304 included therein, where an input of the adaptive ANC filter 304 is derived from the error signal e(n). As shown in FIG. 3, the adaptive ANC filter 304 is implemented by an adaptive gain amplifier 314 and a static filter 316 connected in series, where the static filter 316 has a fixed transfer function W_{FB}(z) defined by fixed filter coefficients, and the adaptive gain amplifier 314 has a controllable gain G_{FB}(n).

The filter 310 has a transfer function Ŝ(z) which is an estimation of the secondary path transfer function S(z). In this FB ANC structure, the filter 310 and the combining circuit 312 are jointly used for generating an estimated signal \hat{d}(n) from the measured error signal e(n), where the estimated signal \hat{d}(n) represents an estimation of d(n) (e.g., d(n)=P(z)*x(n), where P(z) is unknown, and x(n) is unavailable due to absence of the reference microphone 102). Specifically, the estimated signal \hat{d}(n) is derived from subtracting an estimated signal û(n) (which is an estimation of signal u(n)) from the error signal e(n).

The leakage detection circuit 308 is arranged to perform leakage detection according to a first input signal S1 and a second input signal S2, and adjust the controllable gain G_{FB}(n) of the adaptive gain amplifier 314 according to a leakage detection result. In this embodiment, the first input signal S1 is set by the estimated signal \hat{d}(n) (i.e., S1=\hat{d}(n)), and the second input signal S2 is set by the error signal e(n) (i.e., S2=e(n)). Hence, the leakage detection circuit 308 may obtain the leakage detection result through calculating a ratio of the second input signal S2 to the first input signal S1 (i.e.,

$$\frac{E ( z )}{\hat{D} ( z )} )$$

as a leakage detection factor which is proportional to the leakage condition.

Signals of the adaptive ANC system 300 may be expressed using the following formulas.

$$\hat{D} ( z ) = E ( z ) - \hat{S} ( z ) {G}_{F B} ( z ) {W}_{F B} ( z ) \hat{D} ( z ) \qquad ( 5 )$$

$$\hat{D} ( z ) = \frac{E ( z )}{1 + \hat{S} ( z ) {G}_{F B} ( z ) {W}_{F B} ( z )} \qquad ( 6 )$$

$$E ( z ) = D ( z ) + S ( z ) {G}_{F B} ( z ) {W}_{F B} ( z ) \hat{D} ( z ) = D ( z ) + S ( z ) {G}_{F B} ( z ) {W}_{F B} ( z ) \frac{E ( z )}{1 + \hat{S} ( z ) {G}_{F B} ( z ) {W}_{F B} ( z )} = D ( z ) + \frac{S ( z ) {G}_{F B} ( z ) {W}_{F B} ( z ) E ( z )}{1 + \hat{S} ( z ) {G}_{F B} ( z ) {W}_{F B} ( z )} \qquad ( 7 )$$

$$\frac{E ( z )}{D ( z )} = \frac{1 + \hat{S} ( z ) {G}_{F B} ( z ) {W}_{F B} ( z )}{1 + [ \hat{S} ( z ) - S ( z ) ] {G}_{F B} ( z ) {W}_{F B} ( z )} , where ideally , \hat{D} = D \qquad ( 8 )$$

$$\frac{E ( z )}{\hat{D} ( z )}$$

ratio will increase when S does not mismatch with

$$\hat{S} . \frac{E ( z )}{\hat{D} ( z )}$$

could be taken as a leakage detection factor. The ratio is directly proportional to the leakage condition and the filter gain. In other words, when the leakage detection factor becomes larger, the filter coefficients should be larger, resulting in a larger filter gain; and when the leakage detection factor becomes smaller, the filter coefficients should be smaller, resulting in a smaller filter gain.

The leakage detection algorithm has lower computation complexity than any LMS-based algorithm. Hence, the proposed ANC circuit 302 with leakage detection has lower computation complexity since it does not use any LMS-based algorithm. Alternatively, the

$$\frac{E ( z )}{X ( z )}$$

ratio used by the proposed leakage detection algorithm may be calculated using an LMS-based algorithm. Compared to a conventional filter controller design that adjusts filter coefficients of an adaptive ANC filter by using an LMS-based algorithm that needs to operate at, for example, 192 KHz and 1024 taps, the proposed leakage detection algorithm only needs an LMS-based algorithm that operates at, for example, 8 KHz and 128 taps to perform filter selection or filter gain adjustment. To put it simply, the

$$\frac{E ( z )}{X ( z )}$$

ratio used by the proposed leakage detection algorithm may be obtained with/without the use of an LMS-based algorithm. No matter whether an LMS-based algorithm is used, the leakage detection algorithm has lower computation complexity compared to the conventional filter controller design.

It should be noted that the adaptive gain amplifier 314 is an LTI system, and the adaptive gain amplifier 314 and the static filter 316 may be swapped. In other words, the adaptive gain amplifier 314 may be put before or after the static filter 316, depending upon actual design considerations.

In this embodiment, the adaptive non-ANC filter 306 is an audio equalization filter that is used to compensate the attenuation of speaker's response. Specifically, the adaptive non-ANC filter (i.e., audio equalization filter) 306 is arranged to receive an audio playback signal a(n), and generate an audio equalization signal b(n) according to the audio playback signal a(n); and the combining circuit 313 is arranged to combine the anti-noise signal y(n) and the audio equalization signal b(n). The adaptive non-ANC filter (i.e., audio equalization filter) 306 may be implemented by a selective filter having a plurality of static filters 318_1-318_N (N≥2), where the static filter 318_1 has a fixed transfer function (i.e., a fixed EQ frequency response curve) W_{EQ}1(z) defined by fixed filter coefficients, and the static filter 318_N has a fixed transfer function (i.e., a fixed EQ frequency response curve) W_{EQ}N(z) defined by fixed filter coefficients. The leakage detection circuit 308 is further arranged to select one of the static filters 318_1-318_N as an active audio equalization filter of the adaptive non-ANC filter 306 according to the leakage detection result. The active audio equalization filter generates the audio equalization signal b(n) based on the audio playback signal a(n). The leakage detection algorithm has lower computation complexity than any LMS-based algorithm. Hence, the proposed leakage detection can help to select a proper equalization filter to compensate the attenuation of the speaker's response with lower computation complexity. In this way, the audio playback quality can be enhanced after compensation of the attenuation of the speaker's response. Specifically, pre-defined filters 318_1-318_N can fit the secondary path transfer function to enhance audio quality with lower computation complexity.

Compared to the conventional filter controller using an LMS-based algorithm with high complexity, the proposed leakage detection algorithm only selects a proper audio equalization filter from the filters 318_1-318_N, where the filters 318_1-318_N may be pre-verified to meet requirements of different leakage conditions in which presence of the anti-noise signal component in the error signal is taken into consideration. In other words, the transfer function (i.e., EQ frequency response curves) W_{EQ}1(z) of the static filter 318_1 is properly tuned in the factory for the 1^{st} leakage condition in which the anti-noise signal component is present in the error signal, and the transfer function (i.e., EQ frequency response curves) W_{EQ}N(z) of the static filter 318_N is properly tuned in the factory for the N^{th} leakage condition in which the anti-noise signal component is present in the error signal. Hence, in an actual usage case, the proposed leakage detection algorithm simply selects a proper audio equalization filter from the pre-verified filters 318_1-318_N in response to a current leakage condition, without the need of an LMS-based algorithm with high complexity.

When FB ANC is enabled, the error microphone 104 also picks up the audio playback signal played by the speaker, such that the low-frequency contents of the audio playback signal will also be attenuated. Hence, an audio signal compensation filter can be used to generate audio compensation an signal for signal reduction/cancellation of audio playback contents that are included in the error signal e(n) output from the error microphone 104. In this way, the audio quality enhancement can be achieved by preventing audio playback contents from being erroneously suppressed by FB ANC.

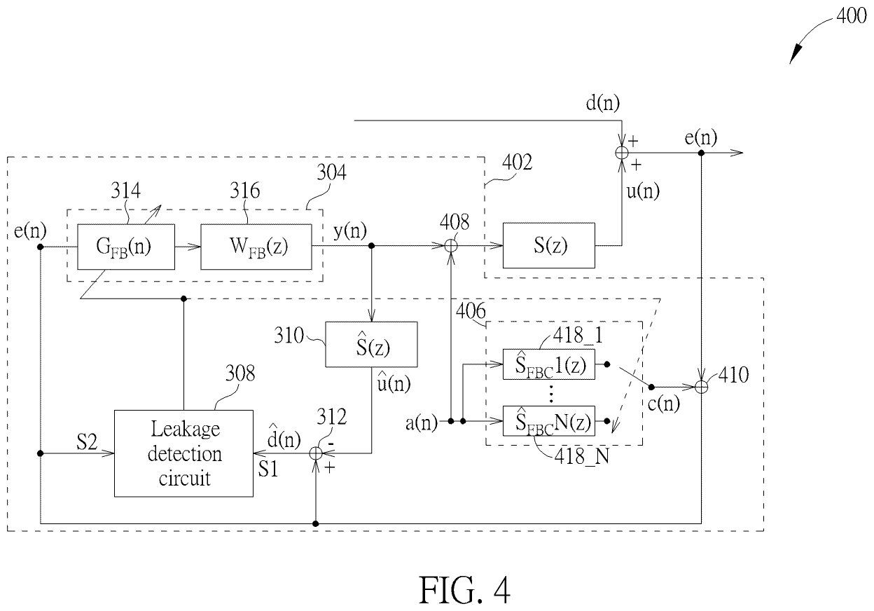

FIG. 4 is a diagram illustrating a third adaptive ANC system with leakage detection according to an embodiment of the present invention. The adaptive ANC system 400 includes an ANC circuit 402. The ANC circuit 402 includes an adaptive non-ANC filter 406, a plurality of combining circuits 408, 410, and the aforementioned adaptive ANC filter 304, leakage detection circuit 308, filter 310, and combining circuit 312. The audio processing circuit (e.g., ANC circuit) 106 shown in FIG. 1 may be realized by the ANC circuit 402. In this embodiment, the ANC circuit 402 employs an adaptive FB ANC structure having the adaptive ANC filter 304 included therein.

The difference between the ANC circuits 302 and 402 is that the adaptive non-ANC filter 406 of the ANC circuit 402 is an audio signal compensation filter that is used to compensate the audio playback attenuation effect resulting from the FB ANC structure in which the error microphone 104 picks up not only the environmental noise but also the audio playback signal played by the speaker. Specifically, the combining circuit 408 is arranged to combine an audio playback signal a(n) and the anti-noise signal y(n); the adaptive non-ANC filter (i.e., audio signal compensation filter or feedback compensation filter) 406 is arranged to receive the audio playback signal a(n), and generate an audio signal compensation signal c(n) according to the audio playback signal a(n); and the combining circuit 410 is arranged to combine the error signal e(n) and the audio signal compensation signal c(n).

It should be noted that, if a transfer function of the audio signal compensation filter (i.e., feedback compensation filter) is not accurately set, the audio playback signal component present in the error signal e(n) cannot be removed sufficiently, and the adaptive gain amplifier 314 cannot be accurately adjusted by the leakage detection circuit 308, which makes low-frequency contents of the audio playback signal in the signal u(n) attenuated.

The adaptive non-ANC filter (i.e., audio signal compensation filter or feedback compensation filter) 406 may be implemented by a selective filter having a plurality of static filters 418_1-418_N (N≥2), where the static filter 418_1 has a fixed transfer function Ŝ_{FBC}1(z) defined by fixed filter coefficients, and the static filter 418_N has a fixed transfer function Ŝ_{FBC}N(z) defined by fixed filter coefficients. The fixed transfer functions Ŝ_{FBC}1(z)-Ŝ_{FBC}N(z) may be estimations of the secondary path transfer function S(z) under different leakage conditions. In addition to adjusting the adaptive ANC filter 304, the leakage detection circuit 308 selects one of the static filters 418_1-418_N as an active feedback compensation filter of the adaptive non-ANC filter 406 according to the leakage detection result. The active feedback compensation filter generates the audio signal compensation signal c(n).

Compared to a fixed audio signal compensation filter, the adaptive non-ANC filter (i.e., audio signal compensation filter) 406 can be adaptively adjusted to fit the actual secondary path transfer function. Specifically, the proposed leakage detection helps to select a proper feedback compensation filter to prevent attenuation of low-frequency components of the audio playback signal played by the speaker when FB ANC is enabled. Pre-defined filters 418_1-418_N can fit the secondary path transfer function to get good compensation with lower computation complexity.

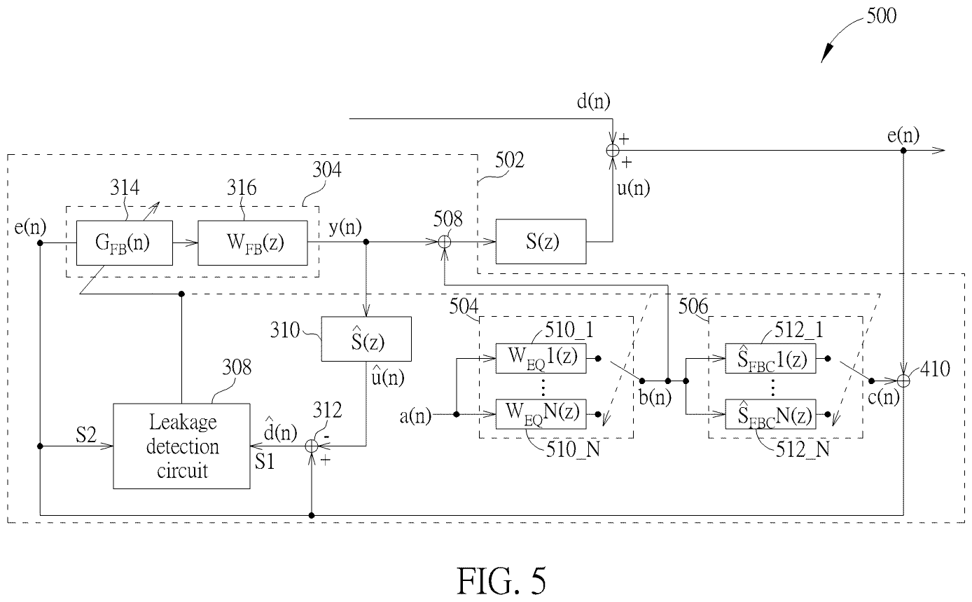

FIG. 5 is a diagram illustrating a fourth adaptive ANC system with leakage detection according to an embodiment of the present invention. The adaptive ANC system 500 includes an ANC circuit 502. The ANC circuit 502 includes a plurality of adaptive non-ANC filters 504, 506, a combining circuit 508, and the aforementioned adaptive ANC filter 304, leakage detection circuit 308, filter 310, and combining circuits 312, 410. The audio processing circuit (e.g., ANC circuit) 106 shown in FIG. 1 may be realized by the ANC circuit 502. In this embodiment, the ANC circuit 502 employs an adaptive FB ANC structure having the adaptive ANC filter 304 included therein. The difference between the ANC circuits 502 and 302/402 is that the ANC circuit 502 includes more than one adaptive non-ANC filter. For example, the adaptive non-ANC filter 504 is an audio equalization filter that is used to compensate attenuation of speaker's response, and the adaptive non-ANC filter 506 is an audio signal compensation filter that is used to compensate the audio playback attenuation effect resulting from the FB ANC structure in which the error microphone 104 picks up not only the environmental noise but also the audio playback signal played by the speaker, where the secondary path transfer function may vary due to different leakage conditions resulting from user's different wearing styles of the earphone device.

The adaptive non-ANC filter (i.e., audio equalization filter) 504 is arranged to receive an audio playback signal a(n), and generate an audio equalization signal b(n) according to the audio playback signal a(n). The combining circuit 508 is arranged to combine the anti-noise signal y(n) and the audio equalization signal b(n). The adaptive non-ANC filter (i.e., audio signal compensation filter) 506 is arranged to receive the audio equalization signal b(n), generate an audio signal compensation signal c(n) according to the audio equalization signal b(n), and output the audio signal compensation signal c(n) to the combining circuit 410.

The adaptive non-ANC filter (i.e., audio equalization filter or feedback compensation filter) 504 may be implemented by a selective filter having a plurality of static filters 510_1-510_N (N≥2), where the static filter 510_1 has a fixed transfer function (i.e., a fixed EQ frequency response curve) W_{EQ}1(z) defined by fixed filter coefficients, and the static filter 510_N has a fixed transfer function (i.e., a fixed EQ frequency response curve) W_{EQ}N(z) defined by fixed filter coefficients. The adaptive non-ANC filter (i.e., audio signal compensation filter) 506 may be implemented by a selective filter having a plurality of static filters 512_1-512_N (N≥2), where the static filter 512_1 has a fixed transfer function Ŝ_{FBC}1(z) defined by fixed filter coefficients, and the static filter 512_N has a fixed transfer function Ŝ_{FBC}N(z) defined by fixed filter coefficients. The fixed transfer functions Ŝ_{FBC}1(z)-Ŝ_{FBC}N(z) may be estimations of the secondary path transfer function S(z) under different leakage conditions.

In addition to adjusting the adaptive ANC filter 304, the leakage detection circuit 308 selects one of the static filters 510_1-510_N as an active audio equalization filter of the adaptive non-ANC filter 504 according to the leakage detection result, and selects one of the static filters 512_1-512_N as an active feedback compensation filter of the adaptive non-ANC filter 506 according to the leakage detection result. The active audio equalization filter generates the audio equalization signal b(n) based on the audio playback signal a(n). The active feedback compensation filter generates the audio signal compensation signal c(n) based on the audio equalization signal b(n).

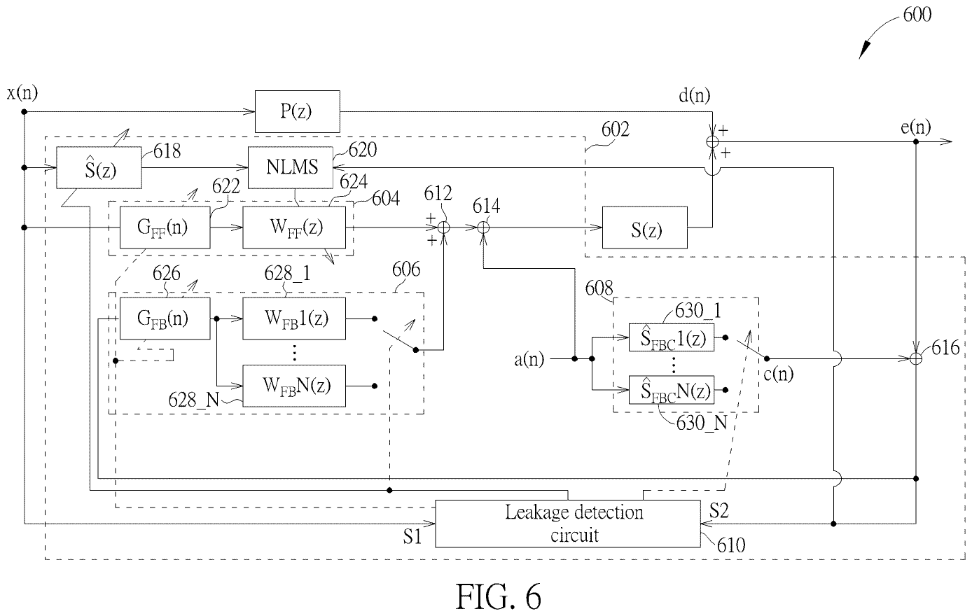

FIG. 6 is a diagram illustrating a fifth adaptive ANC system with leakage detection according to an embodiment of the present invention. The adaptive ANC system 600 includes an ANC circuit 602. The audio processing circuit (e.g., ANC circuit) 106 shown in FIG. 1 may be realized by the ANC circuit 602. In this embodiment, the ANC circuit 602 employs an adaptive hybrid ANC structure which is a combination of an adaptive FF ANC structure and an adaptive FB ANC structure, and has one adaptive ANC filter 604 for the adaptive FF ANC structure and another adaptive ANC filter 606 for the adaptive FB ANC structure. In addition to the adaptive ANC filters 604 and 606, the ANC circuit 602 includes an adaptive non-ANC filter 608, a leakage detection circuit 610, a plurality of combining circuits 612, 614, 616, a filter 618, and an LMS-based filter controller (labeled by “NLMS”) 620. The filter 618 has a transfer function Ŝ(z) which is an estimation of the secondary path transfer function S(z). The combining circuit 612 combines outputs of the adaptive ANC filters 604 and 606 to generate the anti-noise signal.

In this embodiment, the adaptive ANC filter 604 may be jointly controlled by the leakage detection circuit 610 and the LMS-based filter controller 620 to improve the ANC performance. Specifically, the adaptive ANC filter 604 includes an adaptive gain amplifier 622 and an adaptive filter 624 connected in series. The adaptive ANC filter 606 is implemented by a selective filter including an adaptive gain amplifier 626 and a plurality of static filters 628_1-628_N (N≥2). The leakage detection circuit 610 is arranged to perform leakage detection according to a first input signal S1 (S1=x(n)) and a second input signal S2 (S2=e(n)), adjust the controllable gain G_{FF}(n) of the adaptive gain amplifier 622 and the controllable gain G_{FB}(n) of the adaptive gain amplifier 626 according to a leakage detection result, and select one of the static filters 628_1-628_N as an active filter of the adaptive ANC filter 606 according to the leakage detection result. The LMS-based filter controller 620 is arranged to adjust a transfer function W_{FF}(z) of the adaptive filter 624 according to an LMS-based algorithm (e.g., a filtered-x normalized least mean square (FxNLMS) algorithm). For example, the Fx-NLMS based adaptive filter 624 has the transfer function W_{FF}(z) defined by filter coefficients that are adaptively adjusted through the Fx-NLMS algorithm.

In some embodiments of the present invention, the leakage detection circuit 610 may further refer to the leakage detection result to adjust the transfer function Ŝ(z) of the filter 618 for improving the secondary path estimation accuracy. However, this is for illustrative purposes only, and is not meant to be a limitation of the present invention.

The adaptive non-ANC filter 608 is an audio signal compensation filter that is used to compensate the audio playback attenuation effect resulting from the FB ANC structure in which the error microphone 104 picks up not only the environmental noise but also the audio playback signal played by the speaker. Specifically, the combining circuit 614 is arranged to combine an audio playback signal a(n) and the anti-noise signal (which is an output of the combining circuit 612); the adaptive non-ANC filter (i.e., audio signal compensation filter) 608 is arranged to receive the audio playback signal a(n), and generate an audio signal compensation signal c(n) according to the audio playback signal a(n); and the combining circuit 616 is arranged to combine the error signal e(n) and the audio signal compensation signal c(n). The adaptive non-ANC filter (i.e., audio signal compensation filter) 608 may be implemented by a selective filter having a plurality of static filters 630_1-630_N (N≥2), where the static filter 630_1 has a fixed transfer function Ŝ_{FBC}1(z) defined by fixed filter coefficients, and the static filter 630_N has a fixed transfer function Ŝ_{FBC}N(z) defined by fixed filter coefficients. The fixed transfer functions Ŝ_{FBC}1(z)-Ŝ_{FBC}N(z) may be estimations of the secondary path transfer function S(z) under different leakage conditions. In addition to adjusting the adaptive ANC filters 604 and 606, the leakage detection circuit 610 selects one of the static filters 630_1-630_N as an active feedback compensation filter of the adaptive non-ANC filter 608 according to the leakage detection result.

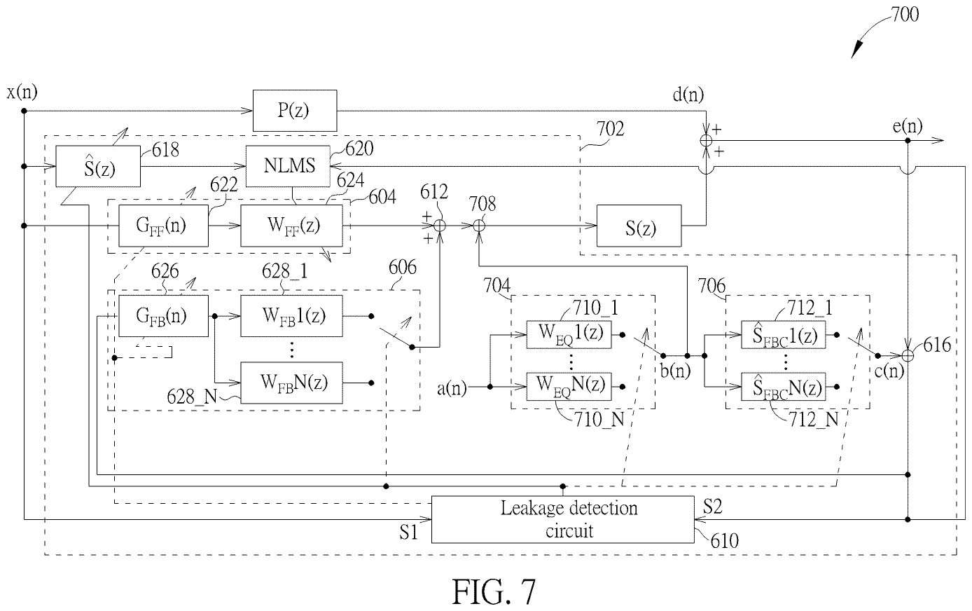

FIG. 7 is a diagram illustrating a sixth adaptive ANC system with leakage detection according to an embodiment of the present invention. The adaptive ANC system 700 includes an ANC circuit 702. The audio processing circuit (e.g., ANC circuit) 106 shown in FIG. 1 may be realized by the ANC circuit 702. In this embodiment, the ANC circuit 702 employs an adaptive hybrid ANC structure which is a combination of an adaptive FF ANC structure and an adaptive FB ANC structure. The ANC circuit 702 includes a plurality of adaptive non-ANC filters 704, 706, a combining circuit 708, and the aforementioned adaptive ANC filters 604, 606, leakage detection circuit 610, filter 618, and combining circuits 612, 616. The difference between the ANC circuits 702 and 602 is that the ANC circuit 702 includes more than one adaptive non-ANC filter. For example, the adaptive non-ANC filter 704 is an audio equalization filter that is used to compensate attenuation of speaker's response, and the adaptive non-ANC filter 706 is an audio signal compensation filter that is used to compensate the audio playback attenuation effect resulting from the FB ANC structure in which the error microphone 104 picks up not only the environmental noise but also the audio playback signal played by the speaker, where the secondary path transfer function may vary due to different leakage conditions resulting from user's different wearing styles of the earphone device.

The adaptive non-ANC filter (i.e., audio equalization filter) 704 is arranged to receive an audio playback signal a(n), and generate an audio equalization signal b(n) according to the audio playback signal a(n). The combining circuit 708 is arranged to combine the anti-noise signal (which is an output of the combining circuit 612) and the audio equalization signal b(n). The adaptive non-ANC filter (i.e., audio signal compensation filter) 706 is arranged to receive the audio equalization signal b(n), generate an audio signal compensation signal c(n) according to the audio equalization signal b(n), and output the audio signal compensation signal c(n) to the combining circuit 616.

The adaptive non-ANC filter (i.e., audio equalization filter) 704 may be implemented by a selective filter having a plurality of static filters 710_1-710_N (N≥2), where the static filter 710_1 has a fixed transfer function (i.e., a fixed EQ frequency response curve) W_{EQ}1(z) defined by fixed filter coefficients, and the static filter 710_N has a fixed transfer function (i.e., a fixed EQ frequency response curve) W_{EQ}N(z) defined by fixed filter coefficients. The adaptive non-ANC filter (i.e., audio signal compensation filter) 706 may be implemented by a selective filter having a plurality of static filters 712_1-712_N (N≥2), where the static filter 712_1 has a fixed transfer function Ŝ_{FBC}1(z) defined by fixed filter coefficients, and the static filter 712_N has a fixed transfer function Ŝ_{FBC}N(z) defined by fixed filter coefficients. The fixed transfer functions Ŝ_{FBC}1(z)-Ŝ_{FBC}N(z) may be estimations of the secondary path transfer function S(z) under different leakage conditions. In addition to adjusting the adaptive ANC filters 604 and 606, the leakage detection circuit 610 selects one of the static filters 710_1-710_N as an active audio equalization filter of the adaptive non-ANC filter 704 according to the leakage detection result, and selects one of the static filters 712_1-712_N as an active feedback compensation filter of the adaptive non-ANC filter 706 according to the leakage detection result. The active audio equalization filter generates the audio equalization signal b(n) based on the audio playback signal a(n). The active feedback compensation filter generates the audio signal compensation signal c(n) based on the audio equalization signal b(n).

In above embodiments, each ANC circuit includes adaptive ANC filter(s) and adaptive non-ANC filter(s), all of which are adjusted by the proposed leakage detection circuit. However, this is for illustrative purposes only, and is not meant to be a limitation of the present invention. In an alternative design, the adaptive ANC filter(s) may be replaced by static ANC filter(s). In other words, an ANC circuit, having static ANC filter(s) for noise reduction/cancellation and adaptive non-ANC filter(s) adjusted by the proposed leakage detection circuit for audio equalization and/or audio signal compensation, still falls within the scope of the present invention.

Furthermore, in above embodiments, each adaptive non-ANC filter is implemented by a selective filter having multiple static filters. However, this is for illustrative purposes only, and is not meant to be a limitation of the present invention. In practice, the present invention has no limitations on implementation of the adaptive non-ANC filter. For example, the adaptive non-ANC filter may be implemented by an adaptive gain amplifier and a static filter connected in series, where the adaptive gain amplifier is adjusted by the proposed leakage detection circuit. This alternative design also falls within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An audio processing circuit comprising:
at least one audio filter, arranged to control an output signal for an audio function;
at least one adaptive non-active noise control (non-ANC) filter, arranged to generate at least one non-anti-noise signal according to an audio playback signal; and
a leakage detection circuit, arranged to perform leakage detection according to a first input signal and a second input signal, and adjust the at least one adaptive non-ANC filter according to a leakage detection result, wherein the first input signal is indicative of noise signal signature, and the second input signal is derived from an error signal output by an error microphone that picks up remnant noise resulting from the audio function.

2. The audio processing circuit of claim 1, wherein the first input signal is derived from a reference signal output by a reference microphone that picks up ambient noise.

3. The audio processing circuit of claim 1, wherein the first input signal is derived from an estimated signal of a noise signal at a position where the audio function occurs.

4. The audio processing circuit of claim 1, wherein the at least one audio filter comprises an adaptive filter, and the leakage detection circuit is further arranged to adjust the adaptive filter according to the leakage detection.

5. The audio processing circuit of claim 1, wherein the at least one adaptive non-ANC filter comprises:
an adaptive audio equalization filter, arranged to receive the audio playback signal, and generate an audio equalization signal according to the audio playback signal; and
the audio processing circuit further comprises:
a first combining circuit, arranged to combine the output signal and the audio equalization signal.

6. The audio processing circuit of claim 5, wherein the at least one adaptive non-ANC filter further comprises:
an adaptive audio signal compensation filter, arranged to receive the audio equalization signal, and generate an audio signal compensation signal according to the audio equalization signal; and
the audio processing circuit further comprises:
a second combining circuit, arranged to combine the error signal and the audio signal compensation signal.

7. The audio processing circuit of claim 1, wherein the at least one adaptive non-ANC filter comprises:
an adaptive audio signal compensation filter, arranged to receive the audio playback signal, and generate an audio signal compensation signal according to the audio playback signal; and
the audio processing circuit further comprises:
a combining circuit, arranged to combine the error signal and the audio signal compensation signal.

8. The audio processing circuit of claim 1, wherein the at least one adaptive non-ANC filter comprises an adaptive filter, the adaptive filter comprises a plurality of static filters, and the leakage detection circuit is arranged to select one of the static filters as an active filter according to the leakage detection result.

9. The audio processing circuit of claim 1, wherein the audio processing circuit is an ANC circuit, each of the at least one audio filter is an ANC filter, the output signal is an anti-noise signal, and the audio function is noise reduction; or
wherein each of the at least one audio filter is a pass-through (PT) filter.

10. An audio processing method comprising:
controlling, by at least one audio filter, an output signal for an audio function;
generating, by at least one adaptive non-anti noise control (non-ANC) filter, at least one non-anti-noise signal according to an audio playback signal;
performing leakage detection according to a first input signal and a second input signal, wherein the first input signal is indicative of noise signal signature, and the second input signal is derived from an error signal output by an error microphone that picks up remnant noise resulting from the audio function; and
adjusting the at least one adaptive non-ANC filter according to a leakage detection result.

11. The audio processing method of claim 10, wherein the first input signal is derived from a reference signal output by a reference microphone that picks up ambient noise.

12. The audio processing method of claim 10, wherein the first input signal is derived from an estimated signal of a noise signal at a position where the audio function occurs.

13. The audio processing method of claim 10, wherein the at least one audio filter comprises an adaptive filter, and the audio processing method further comprises:
adjusting the adaptive filter according to the leakage detection.

14. The audio processing method of claim 10, wherein the at least one adaptive non-ANC filter comprises:
an adaptive audio equalization filter, arranged to receive the audio playback signal, and generate an audio equalization signal according to the audio playback signal; and
the audio processing method further comprises:
combining the output signal and the audio equalization signal.

15. The audio processing method of claim 14, wherein the at least one adaptive non-ANC filter further comprises:
an adaptive audio signal compensation filter, arranged to receive the audio equalization signal, and generate an audio signal compensation signal according to the audio equalization signal; and
the audio processing method further comprises:
combining the error signal and the audio signal compensation signal.

16. The audio processing method of claim 10, wherein the at least one adaptive non-ANC filter comprises:
an adaptive audio signal compensation filter, arranged to receive the audio playback signal, and generate an audio signal compensation signal according to the audio playback signal; and
the audio processing method further comprises:
combining the error signal and the audio signal compensation signal.

17. The audio processing method of claim 10, wherein the at least one adaptive non-ANC filter comprises an adaptive filter, the adaptive filter comprises a plurality of static filters, and adjusting the at least one adaptive non-ANC filter according to the leakage detection result comprises:
selecting one of the static filters as an active filter according to the leakage detection result.

18. The audio processing method of claim 10, wherein the audio processing method is an ANC method, each of the at least one audio filter is an ANC filter, the output signal is an anti-noise signal, and the audio function is noise reduction; or
wherein each of the at least one audio filter is a pass-through (PT) filter.

19. An audio processing circuit comprising:
at least one adaptive non-active noise control (non-ANC) filter, arranged to generate at least one non-anti-noise signal according to an audio playback signal; and
a leakage detection circuit, arranged to perform leakage detection according to a first input signal indicative of noise signal signature and a second input signal derived from an error signal, and adjust the at least one adaptive non-ANC filter according to a leakage detection result,
wherein the at least one adaptive non-ANC filter is adjusted without being applied a least mean square (LMS) based algorithm.
